(19) United States
(12) Patent Application Publication
(10) Pub. No.: US 2008/0244141 A1
(43) Pub. Date: Oct. 2, 2008

(54) HIGH BANDWIDTH CABLE EXTENSIONS

(75) Inventor: Leonard Babin, Newberg, OR (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/694,219

(22) Filed: Mar. 30, 2007

(51) Int. Cl. G06F 13/00

(52) U.S. Cl. 710/301

(57) ABSTRACT

An adapter has a first interface shaped and configured for removable mechanical and electrical attachment to a PCIe-based computer system and a second interface shaped and configured for removable mechanical and electrical attachment to a PCIe-based peripheral device. The adapter includes a network between and electrically connecting the interfaces in a pass-through configuration and according to PCIe-bases bus specifications.

### FIELD

The present disclosure relates to high bandwidth cable extensions. More specifically, the present disclosure relates to external extensions for PCIe Express Card and Mini-Card interfaces. It may be used to extend and enhance such specifications as, but not limited to, PCIe, PCIe Bus, ExpressCard, Express Mini-Card, and PCIe Cable.

### BACKGROUND

The Peripheral Component Interconnect (PCI) is a bus specification for attaching peripheral devices to a computer motherboard. These devices may include IC's fitted to the motherboard itself or expansion cards that fit into sockets on the motherboard. Peripheral Component Interconnect Extended (PCI-X) was designed to supersede PCI. It is essentially a faster version of PCI, running at twice the speed, but is similar in physical implementation and basic design.

The PCI Express Specification (PCIe) is a faster and more flexible system intended to replace PCI and PCI-X. While PCIe has the same software interface as PCI and can be bridged to PCI, the cards are not compatible. The PCIe specification describes feature size and power requirements for full sized PCIe cards used in desktop and server systems. Two additional PCIe card ports have been standardized for use on mobile systems where form factor and power constraints do not allow full size cards. These interfaces are called the PCIe Mini-Card interface and the Express-Card interface. Each of these interface standards describe a method for small form factor (SFF) PCIe communication devices to connect to the internal PCIe bus. However, many of the new communication protocols relevant to mobile systems have circuit implementations that cannot be accommodated by these SFF interfaces. To take advantage of these new protocols, Original Equipment Manufacturers (OEMs) will be required to develop custom methods for expansion to encompass future communications technologies, adding to system cost.

A PCIe Cable Interface specification is presently under development by the PCI Express Special Interest Group (PCIeSIG) to extend the input/output capabilities of systems and to support a wide range of system implementations and externally added devices. PCIe Cable technology will allow creation of easy to install external devices no longer limited by form-factor constraints and with potential data rates far exceeding Universal Serial Bus (USB) and other cabled technologies in use today.

PCIe Cable implementations do not yet exist in the market place. However, the current version of the PCIe Cable Specification suggests that OEM's and developers add the cable receptacle directly to a motherboard or add-in card design to provide cable access to the main system PCIe bus. Such a method requires costly system re-design and increases complications for small form factor and mobile systems where space may be of concern.

This disclosure provides a method for extending the existing PCI Express Mini-Card and ExpressCard connectors to allow system integration of larger form factor radios and other high speed PCI Express based devices in a non-intrusive manner. This disclosure thereby enhances configuration options without necessitating system re-design.

### BRIEF DESCRIPTION OF DRAWINGS

Features and advantages of the claimed subject matter will be apparent from the following Detailed Description, which should be considered with reference to the accompanying drawings, wherein:

FIG. 1 is an exploded top view of a high bandwidth cable and a laptop computer with a PCIe ExpressCard cable adapter in accordance with the disclosure, ready for use in attaching an external PCIe device;

FIG. 2 is a top view of the cable, computer and adapter of FIG. 1 in the assembled state and, with the adapter plugged into the computer's PCIe ExpressCard slot;

FIG. 3 is a simplified schematic depicting the connector pin descriptions for the ExpressCard cable adapter of FIG. 1, and the pin list table for the 18pin SMT cable receptacle;

FIG. 4 is a top view of a PCIe Mini-Card cable adapter with a high bandwidth cable attached;

FIG. 5 is a top view of the Mini-Card cable adapter and cable of FIG. 4 plugged into a standard Mini-Card connector on a typical mobile platform mother board and ready for attachment;

FIG. 6 is a top view of the Mini-Card cable adapter and cable of FIGS. 4 and 5 plugged into a custom PCB;

FIG. 7 is a top view of the Mini-Card cable adapter and cable of FIGS. 4 and 5 plugged into an Add-in Card; and

FIG. 8 is a simplified schematic depicting the connector pin descriptions for the Mini-Card cable adapter of FIG. 4, and the pin list table for the 18pin SMT cable receptacle.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

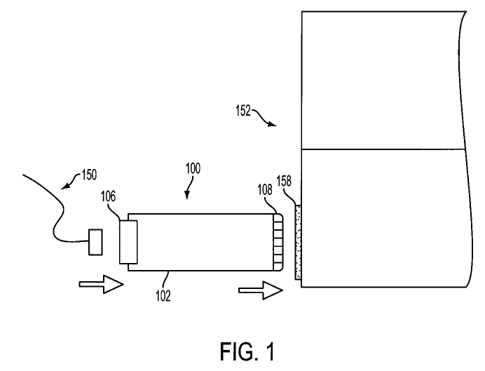

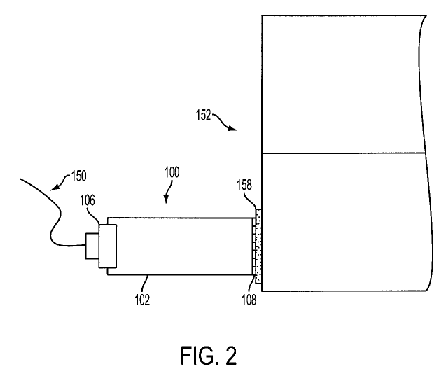

Referring first to FIGS. 1 and 2, there is shown a PCIe ExpressCard cable adapter 100 in accordance with the disclosure and a high bandwidth cable 150 and a laptop computer 152. Adapter 100 comprises of a printed circuit board (PCB) 102, cable end connector portion 106 and system interface end connector portion 108. Adapter 100 may also include a plurality of PCIe signal traces required for 1-lane operation, including data and clock signals, auxiliary signals and supplemental signals for USB and SM Bus signaling and 3.3V power. Cable end connector portion 106 may comprise an 18pin SMT cable receptacle suitable for one lane of PCIe signaling. System interface end connector portion may comprise a standard PCIe ExpressCard Module Connector 108 following the pin and mechanical form factor requirements of the PCIe ExpressCard Standard, Release 1.0. The signals are routed on adapter 100 from connector 108 to receptacle 106. Adapter 100, with cable 150 and some external PCIe device attached, may plug into a standard ExpressCard external slot 158 and the device may then be auto detected by the system.

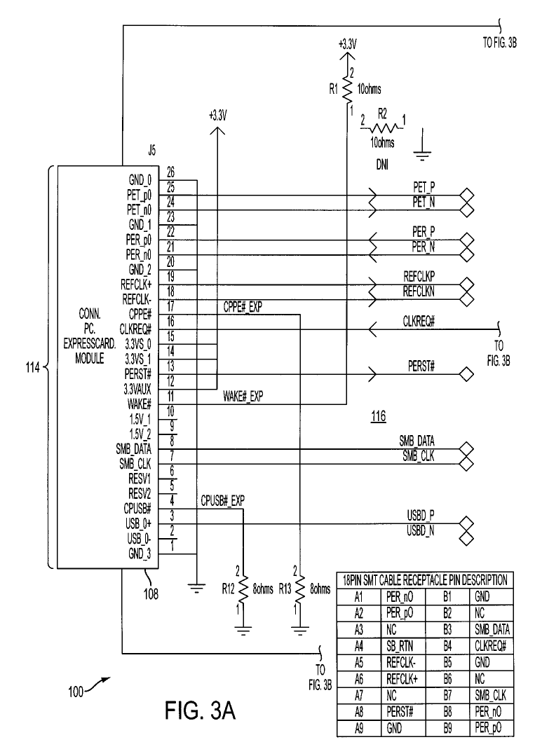

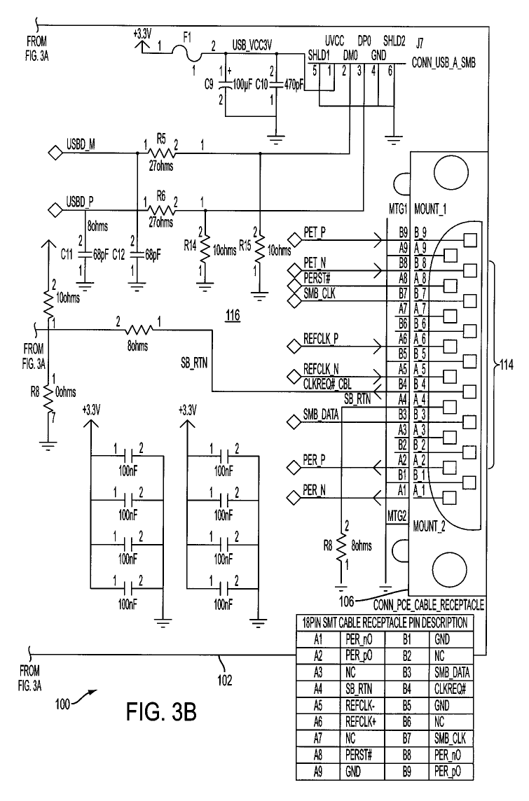

The circuitry for adapter 100 is shown in FIG. 3, where there are shown the pin descriptors 114, also described in the adjoining table. The on-board circuitry 116 consists of pass through connections for the X1 lanes of PCIe signals. The PCIe signals for “transmit”, “receive” and “reference clock” are routed to ensure 100 Ohm differential impedance for noise immunity and improved performance. Auxiliary and supplemental signals are routed in a manner ensuring optimal noise immunity. USB signaling is also routed on the adapter and is also routed for differential impedance of 100 Ohm's. The USB signals are routed to a type-A USB connector supporting the attachment of 3.3 USB I/O devices. This circuitry allows the utilization of a standardized interface for the external non-intrusive connection to the internal PCIe input/output bus. This circuitry and physical arrangement enables the development of a new class of external PCIe devices, which are not bounded by current standardized form factors, such as is required for current ExpressCard devices.

Adapter 100 provides a method for cable access to the system PCIe bus that may take advantage of existing interfaces without having to re-design main system boards. Thus allowing easy retro-fit into current designs and offering a low cost configuration option for OEM's.

Adapter 100 may provide a PCIe cable interface anywhere an ExpressCard slot is available, which may be a native external interface for a laptop system, as shown in FIGS. 1 and 2, or may be a back panel slot on a desktop or server system provided by an internal add-in card.

Because the disclosed adapter is an extension to PCIe related technology, it may provide the PCIeSIG with leverage to enhance acceptance and proliferation of PCIe in general and the PCIe Cable specification in particular. It may provide users, OEM's and developers with an immediate cable interface to any system that supports an ExpressCard slot. This could allow them to integrate any input/output device that supports a PCIe X1 Cable interface without internal system architecture/design changes. Adapter 100 may reduce cost for OEM's and developers by enhancing design reusability, reducing risk to new device implementation and providing easy to implement configuration options. It is extremely useful in test and development environments for activities such as providing a high speed link to experimental platforms, particularly those related to PCIe device development.

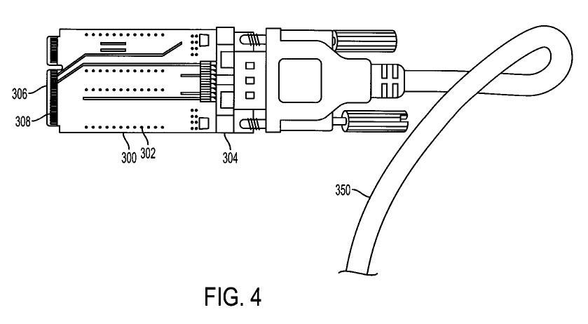

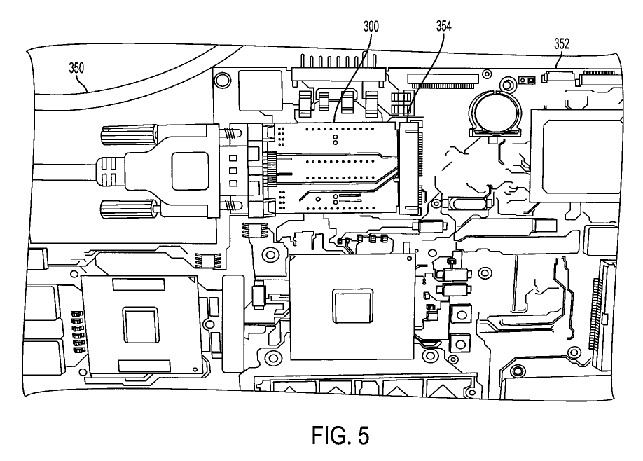

Referring now to FIGS. 4 and 5, there is shown a PCIe Mini-Card Cable adapter 300, a high bandwidth cable 350, and a mobile platform motherboard 352 with a standard Mini-Card connector 354. Adapter 300 extends the existing PCIe Mini-Card connector 354 to allow integration of larger form factor radios and other high speed PCIe-based devices in a non-intrusive manner, thereby enhancing system configuration options without necessitating re-design of the system main board.

Adapter 300 is an extension of PCIe bus technology and can also provide leverage for the PCIeSIG toward more rapid industry adoption of the Cable Specification and development of external PCI Express based devices. This adapter consists of a PCB 302 with cable end connector portion 304 and system interface connector portion 306, and the supports the full complement of PCIe signal traces required for 1-lane operation, including data and clock signals, auxiliary and supplemental signals and 3.3V power.

Cable end connector portion 304 is an 18pin SMT cable receptacle suitable for 1 lane of PCI Express signaling. System interface end connector portion is a standard PCIe Card Module Connector 306 following the pin and mechanical form factor requirements of the PCIe Express Mini-Card Electromechanical Specification, Revision 1.1. The signals are routed on PCB 302 from gold fingers 308 of connector 306 to receptacle 304.

FIG. 4 shows Mini-Card adapter 300 with a high bandwidth cable 350 attached. Although this round cable illustrates the concept, its primary use is for external expansion. For internal expansion on mobile systems a more space saving flat ribbon cable (FRC) may be used.

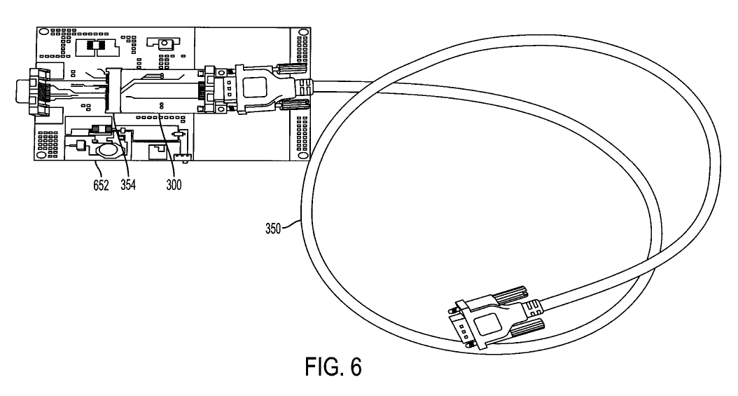

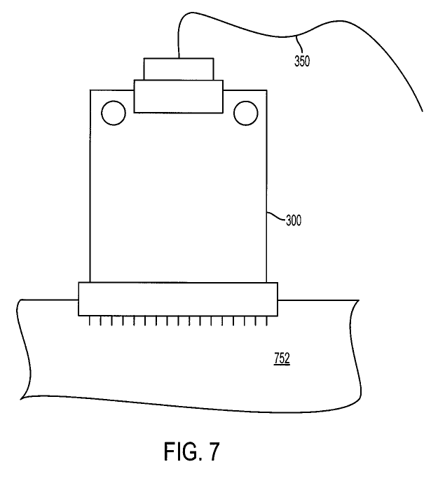

FIG. 5 shows adapter 300 and cable 350 plugged into a standard Mini-Card connector 354 on a typical mobile platform mother board 352. The interface is now ready for attachment of any PCIe-based device that supports a matching cable receptacle. FIG. 6 shows another application for the Mini-Card Cable adapter 300 of FIGS. 4 and 5. In this figure, adapter 300 and cable 350 are plugged into another custom PCB 652. FIG. 7 shows the Mini-Card cable adapter 300 of FIGS. 4 and 5 and cable 350 plugged into an Add-in Card 752.

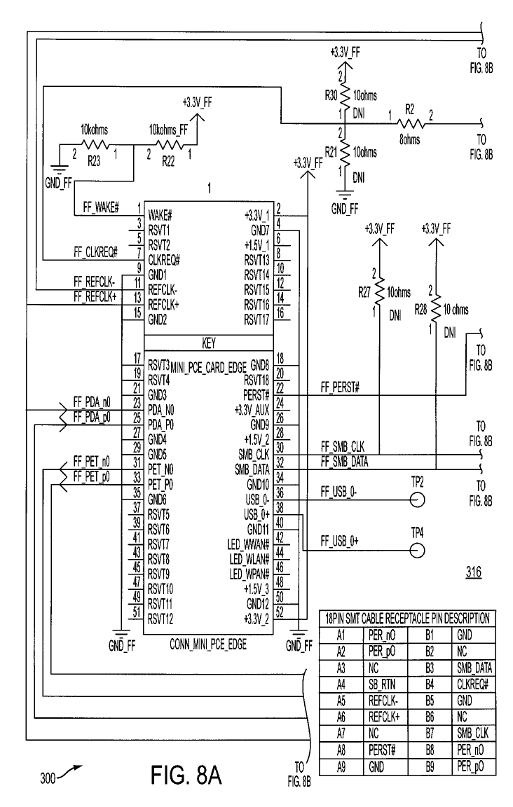

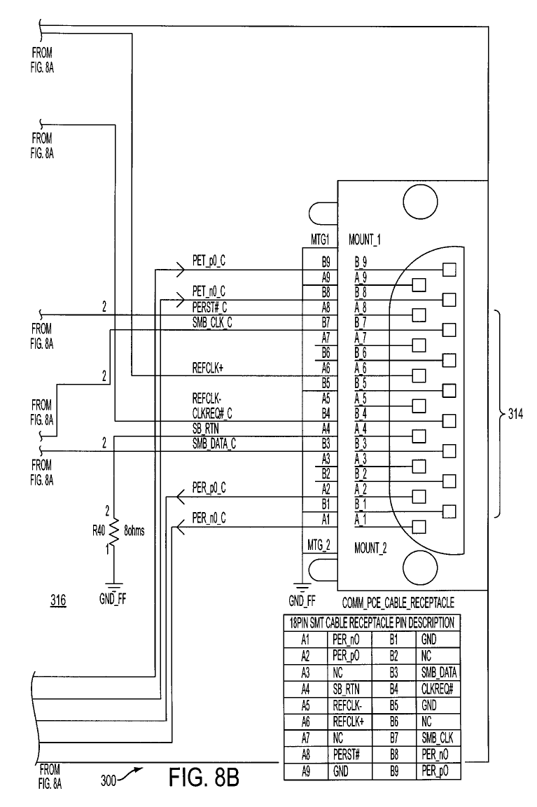

The circuit diagram for adapter 300 is shown in FIG. 8, where there are shown the pin descriptors 314, also described in the adjoining table. The on-board circuitry 316 consists of pass through connections for the X1 lanes of PCIe signals. The PCIe signals for transmit, receive and reference clock are routed to ensure 100 Ohm differential impedance for noise immunity and improved performance. Auxiliary and supplemental signals are routed in a manner ensuring optimal noise immunity. This circuitry allows the utilization of a standardized interface for the external non-intrusive connection to the internal PCIe input/output bus. As in the previous embodiment, this circuitry and physical arrangement enables the development of a new class of external PCIe devices, which are not bounded by current standardized form factors, such as is required for current Mini-Card devices.

As can be appreciated, the PCIe Mini-Card Adapter 300 provides a PCIe cable interface anywhere a PCI Express Mini-Card slot is available. For OEM's and developers, this can provide an immediate cable interface to any system that supports a PCIe Mini-Card slot, allowing the integration of any input/output device that supports a PCIe X1 cable interface without internal system architecture/design changes. As with the other embodiments, it reduces cost for OEM's and developers by enhancing design reusability, reducing risk to new device implementation and providing easy to implement configuration options. The disclosed embodiments provide methods for cable access to the system PCIe bus that can take advantage of existing interfaces without having to re-design the main system boards, thus allowing retro-fit of future PCIe-based devices into current designs offering low cost configuration options for OEM's.

Various features, aspects, and embodiments have been described herein. The features, aspects, and numerous embodiments described are susceptible to combination with one another as well as to variation and modification, as will be understood by those having skill in the art. The present disclosure should, therefore, be considered to encompass such combinations, variations, and modifications. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. An adapter comprising:
a first interface configured for removable mechanical and electrical attachment to a PCIe-based computer system;
a second interface configured for removable mechanical and electrical attachment to a PCIe-based peripheral device; and
a network electrically connecting said first and second interfaces in a pass-through configuration.

2. The adapter of claim 1, further comprising an extension of PCIe bus technology.

3. The adapter of claim 2, wherein said network comprises pass-through connections for an X1 lane.

4. The adapter of claim 3, wherein said peripheral device comprises a PCIe-based cable.

5. The adapter of claim 4, wherein said second interface comprises an 18pin SMT receptacle-type connector portion.

6. The adapter of claim 5, wherein said first interface comprises a connector portion according to the pin and mechanical form factor requirements of the PCIe Express Mini-Card Electromechanical Specification.

7. The adapter of claim 5, wherein said first interface comprises a connector portion according to the pin and mechanical form factor requirements of the PCIe ExpressCard Standard.

8. The adapter of claim 4, wherein said first interface comprises a connector portion according to the pin and mechanical form factor requirements of the PCIe Express Mini-Card Electromechanical Specification.

9. The adapter of claim 4, wherein said first interface comprises a connector portion according to the pin and mechanical form factor requirements of the PCIe ExpressCard Standard.

10. The adapter of claim 2, wherein said first interface, second interface and network are comprised on a printed circuit board.

11. The adapter of claim 10 wherein said network comprises pass-through connections for an X1 lane.

12. The adapter of claim 11, wherein said peripheral device comprises a PCIe-based cable.

13. The adapter of claim 12, wherein said second interface comprises an 18pin SMT receptacle-type connector portion.

14. The adapter of claim 13, wherein said first interface comprises a connector portion according to the pin and mechanical form factor requirements of the PCIe Express Mini-Card Electromechanical Specification.

15. The adapter of claim 13, wherein said first interface comprises a connector portion according to the pin and mechanical form factor requirements of the PCIe ExpressCard Standard.

16. The adapter of claim 12, wherein said first interface comprises a connector portion according to the pin and mechanical form factor requirements of the PCIe Express Mini-Card Electromechanical Specification.

17. The adapter of claim 12, wherein said first interface comprises a connector portion according to the pin and mechanical form factor requirements of the PCIe ExpressCard Standard.

18. An adapter for removable mechanical and electrical attachment of PCIe-based peripheral devices to PCIe-based computer systems comprising:
a first connector portion according to the pin and mechanical form factor requirements of a PCIe specification, for removable mechanical and electrical attachment to the PCIe-based computer systems;
an 18pin SMT receptacle-type second connector portion, for removable mechanical and electrical attachment to the PCIe-based peripheral devices; and
a printed circuit board comprising a PCIe bus technology network electrically connecting said first and second connector portions in a pass-through configuration.

19. A method for electrically and mechanically attaching a PCIe-based peripheral device to a PCIe-based computer system in a pass-through configuration comprising:
providing a first interface shaped and configured for removable mechanical and electrical attachment to the PCIe-based computer system;
providing a second interface shaped and configured for removable mechanical and electrical attachment to the PCIe-based peripheral device;
providing a network electrically connecting said first and second interfaces in the pass-through configuration;
removably attaching said first interface to the PCIe-based computer system; and
removably attaching said second interface to the PCIe-based peripheral device.
